(19) United States
(12) Patent Application Publication
(10) Pub. No.: US 2025/0242259 A1
(43) Pub. Date: Jul. 31, 2025

(54) STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventor: Tatsuya KURIHARA, Kyoto (JP)

(21) Appl. No.: 19/038,319

(22) Filed: Jan. 27, 2025

(30) Foreign Application Priority Data
Jan. 30, 2024 (JP) 2024-011587

(51) Int. Cl. A63F 13/58; G06T 15/04; G06T 17/20

(52) U.S. Cl. CPC A63F 13/58; G06T 15/04; G06T 17/20; G06T 2210/21

(57) ABSTRACT

An example of an information processing apparatus generates a mesh of an object in a virtual space based on voxel data. The information processing apparatus obtains first material data and second material data as material data that defines a color and/or pattern of the object for each voxel. Before a change event that changes an appearance of the object occurs, a color and/or pattern of a mesh of the object is set based on the first material data. After the change event occurs, the information processing apparatus sets, based on the second material data, a color and/or pattern of a mesh that is generated based on voxel data related to the change target voxels and that corresponds to a portion of a surface of the object.

### CROSS REFERENCE TO RELATED APPLICATION

This application claims priority to Japanese Patent Application No. 2024-011587 filed on Jan. 30, 2024, the entire contents of which are incorporated herein by reference.

### FIELD

The present disclosure relates to a storage medium, an information processing system, an information processing apparatus and an information processing method for generating an object in a virtual space using voxel data.

### BACKGROUND AND SUMMARY

There have been conventional techniques to manage objects using voxel data, and generate meshes of objects in a virtual space based on voxel data.

With conventional techniques, when generating an object in a virtual space using voxel data, it was difficult to achieve such an expression as if there was an outer shell portion on the surface of the object that is thinner than the length of one side of a voxel even by using different appearances (e.g., textures) for voxels corresponding to the surface of the object and voxels corresponding to the inside of the object.

Therefore, the present application discloses a storage medium, an information processing system, an information processing apparatus and an information processing method capable of expressing a thin outer shell portion of an object.
(1)

An example of one or more non-transitory computer-readable storage medium having stored therein instructions that, when executed, cause one or more processors of an information processing apparatus to execute information processing comprising: generating a mesh of an object in a virtual space based on voxel data for each voxel defined in a voxel space that is set in the virtual space; obtaining first material data and second material data as material data that defines a color and/or pattern of the object defined for each voxel; (a) before a change event that changes an appearance of the object occurs, setting a color and/or pattern of a mesh of the object based on the first material data, and (b) after the change event occurs, when the second material data is associated with the first material data that is set for change target voxels, which are voxels at a position at which the change event has occurred, setting, based on the second material data, a color and/or pattern of a mesh that is generated based on voxel data related to the change target voxels and that corresponds to a portion of a surface of the object; and outputting an image of the mesh of the object in the virtual space on a display device.

With configuration (1) above, it is possible to express how a thin surface of the object has been stripped off by a change event, and it is thus possible to express a thin surface of the object.
(2)

When a removal event in which at least a portion of the object is removed occurs, the voxel data related to removal target voxels where the removal event has occurred may be updated so that at least a portion of the object is removed in the removal target voxels. The storage medium may have stored therein instructions that cause the information processing apparatus to perform operations further comprising: determining that the change event has occurred in at least one of voxels around the removal target voxels.

With configuration (2) above, when a portion of the object is removed and the inside thereof is exposed, it is possible to express a thin surface of the object.
(3)

A color and/or pattern of at least one mesh may be set based on the second material data. The at least one mesh is generated based on voxel data related to the change target voxels and a position of the at least one mesh has not changed before and after the removal event.

With configuration (3) above, it is possible to make it look like a thin surface of the object has been stripped off without changing the mesh for a portion of the mesh of the object.
(4)

The storage medium may have stored therein instructions that cause the information processing apparatus to perform operations further comprising: when an impact-imparting event in which an impact is imparted on the object occurs, determining that the change event has occurred for voxels that are at positions based on the position at which the impact-imparting event has occurred.

With configuration (4) above, it is possible to make it look like a thin surface of the object has been stripped off for a portion of the mesh of the object.
(5)

A color and/or pattern of at least one mesh may be set based on the second material data. The at least one mesh is generated based on voxel data related to the change target voxels and a position of the at least one mesh has not changed before and after the impact-imparting event.

With configuration (5) above, it is possible to make it look like a thin surface of the object has been stripped off without changing the mesh for a portion of the mesh of the object.
(6)

When the impact-imparting event has occurred a first number of times on the object, it may be determined by the processor that the change event has occurred for voxels of the object in a range in accordance with the impact-imparting event. The storage medium may have stored therein instructions that cause the information processing apparatus to perform operations further comprising: when the impact-imparting event has occurred a second number of times, which is larger than the first number of times, on the object, updating the voxel data related to removal target voxels of the object that are at positions based on the range in accordance with the impact-imparting event so that at least a portion of the object in the removal target voxels is removed. When the impact-imparting event has occurred the second number of times on the object, it may be determined by the processor that the change event has occurred for at least some of the voxels around the removal target voxels.

With configuration (6) above, it is possible to express such an event that a thin surface of the object is stripped off by an impact-imparting event, and then a portion of the object is removed by an additional impact-imparting event.
(7)

Third material data may be obtained by the processor. In response to occurrence of the change event for a first time, a color and/or pattern of a mesh of the object generated based on voxel data related to the change target voxels that are at positions where the change event for the first time has occurred may be set based on the second material data set for the change target voxels. In response to occurrence of the change event for a second time for the change target voxels, when the third material data is associated with the second material data set for the change target voxels at positions where the change event for the second time has occurred, a color and/or pattern of a mesh of the object generated based on voxel data related to the change target voxels may be set based on the third material data.

With configuration (7) above, it is possible to express a voxel object having three layers having different appearances.
(8)

The material data may be related to property data that defines a property of the object for each voxel, and the property data associated with the first material data and the property data associated with the second material data are the same. The storage medium may have stored therein instructions that cause the information processing apparatus to perform operations further comprising: setting a property of the object based on the property data.

With configuration (8) above, it is possible to set a property of the object without being influenced by the appearance of the object.
(9)

The material data may include data representing a texture. The storage medium may have stored therein instructions that cause the information processing apparatus to perform operations further comprising: generating an image of the object by applying, to a mesh that is generated based on the voxel data, a texture that is represented by the material data set for a voxel corresponding to the voxel data.

With configuration (9) above, it is possible to set a color and/or pattern of the object for each voxel.
(10)

An image of the object may be generated by rendering a mesh that is generated based on voxel data of the change target voxels and voxel data of voxels that are different from the change target voxels so that there is a gradation from a texture represented by the first material data to a texture represented by the second material data.

With configuration (10) above, it is possible to make the appearance of the object more natural.
(11)

Another example of one or more non-transitory computer-readable storage medium having stored therein instructions that, when executed, cause one or more processors of an information processing apparatus to execute information processing comprising: generating a mesh of an object in a virtual space based on voxel data for each voxel defined in a voxel space that is set in the virtual space; before a removal event in which a portion of the object is removed occurs, rendering a first color and/or pattern on the mesh of the object; and outputting an image of the mesh of the object in the virtual space on a display device. After the removal event occurs, the voxel data is updated so that a portion of the object is removed. A second color and/or pattern different from the first color and/or pattern is rendered on a mesh of an exposed portion of the object that is exposed as a result of the removal and a mesh for at least a portion around the mesh of the exposed portion.

With configuration (11) above, when a portion of the object is removed and the inside thereof is exposed, it is possible to express a thin surface of the object.
(12)

The second color and/or pattern may be rendered on a mesh that is for at least a portion around the mesh of the exposed portion and that is at least one mesh whose position has not changed before and after the removal event.

With configuration (12) above, it is possible to make it look like a thin surface of the object has been stripped off without changing the mesh for a portion of the mesh of the object.
(13)

The storage medium may have stored therein instructions that cause the information processing apparatus to perform operations further comprising: obtaining property data that defines a property of the object for each voxel; and setting a property based on the property data for the object in which the first color and/or pattern or the second color and/or pattern is rendered on the mesh. The property data corresponding to the mesh of the first color and/or pattern and the property data corresponding to the mesh of the second color and/or pattern may be the same.

With configuration (13) above, it is possible to change the property of the object without being influenced by the appearance of the object.
(14)

A mesh that is generated based on the voxel data may be rendered by using a texture that is associated with a voxel corresponding to the voxel data.

With configuration (14) above, it is possible to set a color and/or pattern of the voxel object for each voxel.
(15)

A mesh for at least a portion around the mesh of the exposed portion may be rendered so that there is a gradation from the first color and/or pattern to the second color and/or pattern.

With configuration (15) above, it is possible to make the appearance of the object more natural.

Note that the present specification discloses an information processing apparatus (e.g., a terminal device or a server) and an information processing system for executing the various processes recited in (1) to (15) above. The present specification also discloses an information processing method (specifically, a game process method) by which the information processing system executes the various processes recited in (1) to (15) above.

With the storage medium, the information processing system, the information processing apparatus and the information processing method described above, when generating an object in a virtual space using voxel data, it is possible to express a thin surface of the object.

These and other features, aspects and advantages of the subject matter described herein will become more apparent from the following detailed description of the present invention when taken in conjunction with the accompanying drawings.

### BRIEF DESCRIPTION OF THE DRAWINGS

FIG. 1 is a view showing an example of a non-limiting game system;

FIG. 2 is a block diagram showing an example of an internal configuration of a non-limiting main body apparatus;

FIG. 3 is a block diagram showing an example of an internal configuration of a non-limiting main body apparatus, a non-limiting left controller and a non-limiting right controller;

FIG. 4 is a view showing an example of a terrain object, which is a voxel object;

FIG. 5 is a view showing before and after the deletion of a portion of the terrain object shown in FIG. 4;

FIG. 6 is a view showing before and after the deletion of a portion of the terrain object shown in FIG. 4;

FIG. 7 is a diagram showing an example of content of voxel data and content of material information;

FIG. 8 is a diagram showing an example of property information representing properties of materials;

FIG. 9 is a diagram showing an example of texture information representing textures of materials;

FIG. 10 is a diagram showing a method for generating a mesh;

FIG. 11 is a view showing an example of a game image including a terrain object;

FIG. 12 is a view showing an example of how a punch action is performed by a player object against a tree object;

FIG. 13 is a view showing an example of how a portion of a tree object is broken by a punch action by a player object;

FIG. 14 is a diagram showing an example of material information including two different material IDs;

FIG. 15 is a view showing an example of the surface and the inside of a tree object;

FIG. 16 is a view showing an example of a state in which a portion of a tree object has been deleted from the state shown in FIG. 15;

FIG. 17 is a view showing an example of the surface and the inside of a tree object in a case where surface voxels are not specified as change target voxels;

FIG. 18 is a view showing an example of a mesh at the boundary between areas where two different textures are rendered;

FIG. 19 is a view showing how a change event occurs by an impact-imparting event;

FIG. 20 is a view showing an example of the surface and the inside of a tree object when the texture is changed without removing the tree object;

FIG. 21 is a diagram showing an example of various data used for information processes to be performed on a non-limiting game system; and

FIG. 22 is a flow chart showing an example of the flow of a game process to be executed by a non-limiting game system.

### DETAILED DESCRIPTION OF NON-LIMITING EXAMPLE EMBODIMENTS

### 1. Configuration of Game System

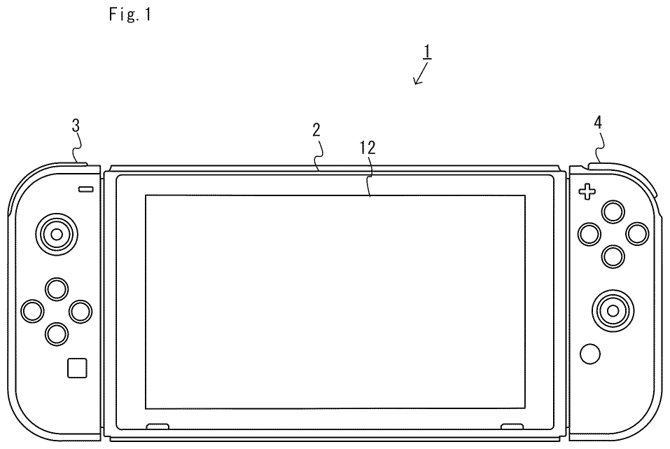

A game system according to an example of an exemplary embodiment is described below. FIG. 1 is an external view of the game system 1. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. Each of the left controller 3 and the right controller 4 is an apparatus including operation sections with which a user provides inputs.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. It should be noted that hereinafter, the left controller 3 and the right controller 4 will occasionally be referred to collectively as a “controller”.

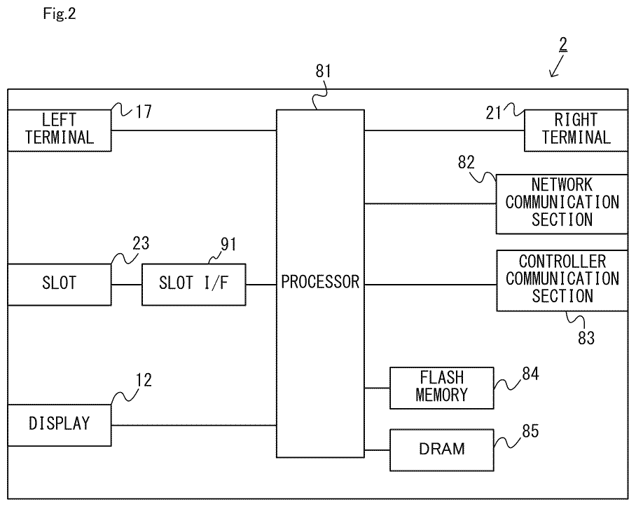

FIG. 2 is a block diagram showing an example of the internal configuration of the main body apparatus 2. The main body apparatus 2 includes components 17, 21, 23, 81 to 85, and 91 shown in FIG. 2 in addition to the components shown in FIG. 1. Some of the components 17, 21, 23, 81 to 85, and 91 may be mounted as electronic components on an electronic circuit board and accommodated in the housing 11.

The main body apparatus 2 includes the display 12. The display 12 displays an image generated by the main body apparatus 2. In the exemplary embodiment, the display 12 is a liquid crystal display device (LCD). The display 12, however, may be a display device of any type.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable storage media.

The main body apparatus 2 includes a slot 23. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17 and the right terminal 21. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. As described above, in the exemplary embodiment, the main body apparatus 2 can perform both wired communication and wireless communication with each of the left controller 3 and the right controller 4.

Further, the display 12 is connected to the processor 81. The processor 81 displays a generated image (e.g., an image generated by executing the above information processing) and/or an externally acquired image on the display 12.

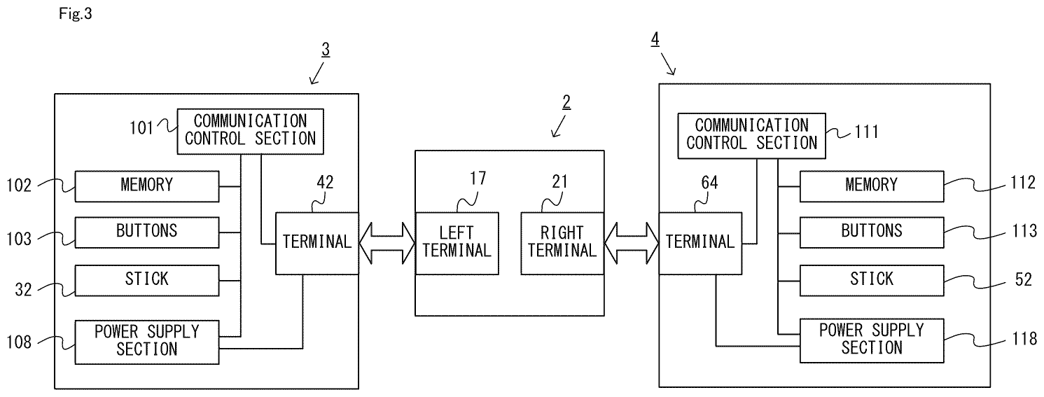

FIG. 3 is a block diagram showing examples of the internal configurations of the main body apparatus 2, the left controller 3, and the right controller 4. It should be noted that the details of the internal configuration of the main body apparatus 2 are shown in FIG. 2 and therefore are omitted in FIG. 3.

The left controller 3 includes a terminal 42 for the left controller 3 to perform wired communication with the main body apparatus 2. The left controller 3 includes a communication control section 101, which communicates with the main body apparatus 2. As shown in FIG. 3, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83).

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes one or more buttons 103. Further, the left controller 3 includes the analog stick (“stick” in FIG. 3) 32. Each the buttons 103 and the analog stick 32 outputs information regarding an operation performed on itself to the communication control section 101 repeatedly at appropriate timing.

The communication control section 101 acquires information regarding an input (specifically, information regarding an operation) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

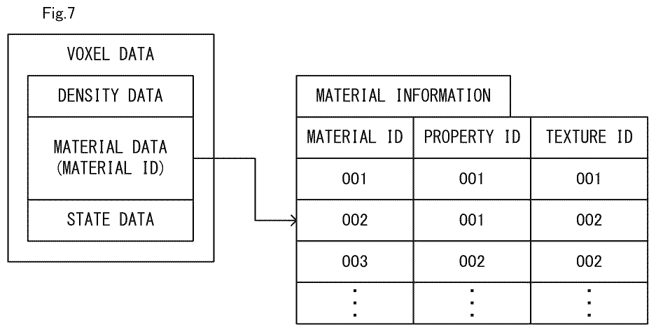

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 3, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Outline of Process on Game System

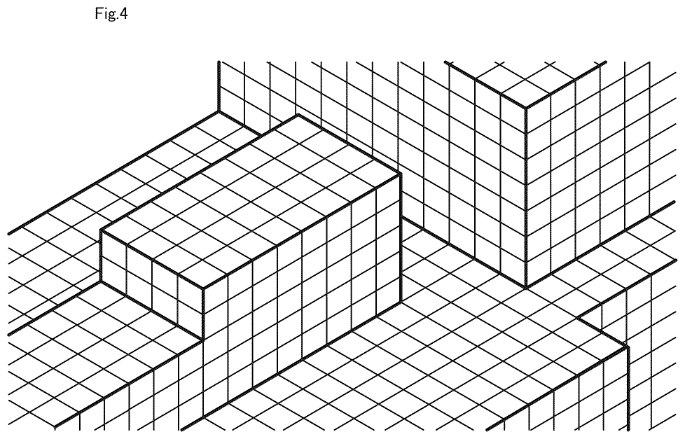

Next, referring to FIG. 4 to FIG. 18, an outline of the process performed on the game system 1 will be described. In the present embodiment, the game system 1 generates a game image in which terrain objects and characters (e.g., the player object controlled by the player) are arranged in a game space, which is a three-dimensional virtual space, and displays the game image on a display device. Note that in the present embodiment, the display device on which the game image is displayed may be the display 12 described above, or may be a display device different from the display 12 (e.g., a stationary or movable monitor connected to the game system 1).

### 2-1. Voxel

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, the game system 1 stores voxel data for each of a plurality of voxels that are set in the game space as data for generating voxel objects in the game space.

FIG. 4 is a view showing an example of a terrain object, which is a voxel object. As shown in FIG. 4, in the present embodiment, a terrain object representing a terrain such as a ground surface has its shape defined by voxel data. The cubes shown in FIG. 4 represent a terrain object. Note that in FIG. 4, voxel boundaries are indicated by thin lines and edges of the terrain object are indicated by thick lines. However, these lines are added for the purpose of making the drawings easier to understand, and there is no need in practice for lines indicating voxel boundaries to be displayed, and there is no need for edges of the terrain object to be drawn thick.

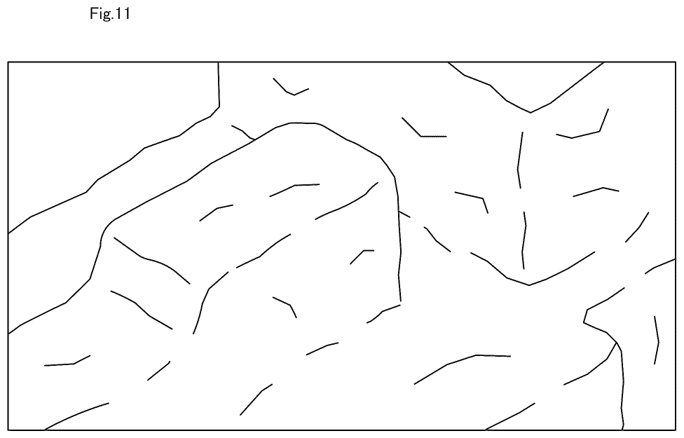

For example, the terrain object shown in FIG. 4 is generated by the following rule: “a cube is placed at the position of a voxel if a parameter (specifically, the density as will be described below) included in the voxel data set for the voxel is greater than a predetermined value, and nothing is placed at the position of the voxel if the parameter is less than or equal to the predetermined value”. In FIG. 4, a terrain object generated by this rule is shown for the purpose of illustrating the relationship between voxels and voxel objects in an easy-to-understand manner. Note however that in the present embodiment, in practice, a voxel object is generated by such a rule that results in a terrain object having a complicated shape in comparison with the cubic voxels, such as a terrain object shown in FIG. 11 to be described below, for example. Note that there is no limitation on the rule for determining the shape of the voxel object based on the voxel data. In other embodiments, the game system 1 may generate a voxel object as shown in FIG. 4 based on the voxel data or may generate a voxel object as shown in FIG. 11 based on the voxel data.

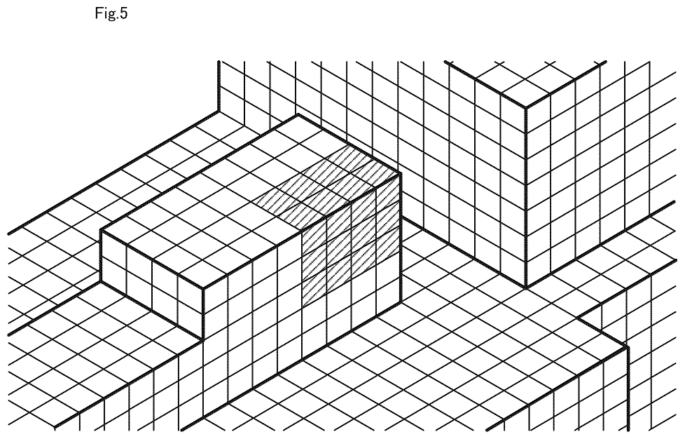

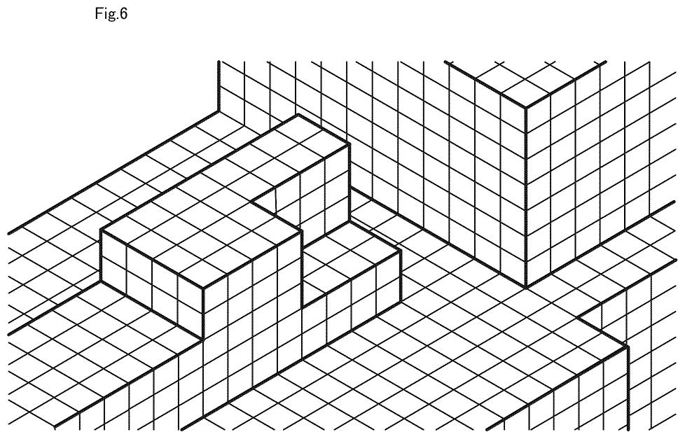

It is possible to change the shape of a voxel object by changing voxel data of voxels. FIG. 5 and FIG. 6 are views showing before and after the removal of a portion of the terrain object shown in FIG. 4. That is, when the hatched portion of the terrain object shown in FIG. 5 is removed, the terrain object changes to a shape as shown in FIG. 6. In such a case, the game system 1 can easily delete the terrain object by rewriting the voxel data so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

FIG. 7 is a diagram showing an example of content of voxel data and content of material information. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 7, voxel data includes density data. The density data represents the density, which is an index used to define the shape of a voxel object in the voxel corresponding to the voxel data (specifically, the shape defined by the mesh to be described below). As will be described in detail below, the position and the shape of the surface of the voxel object (e.g., the mesh to be described below) are determined based on this density. In other words, in the present embodiment, this density is used to generate a mesh that defines the surface of the voxel object.

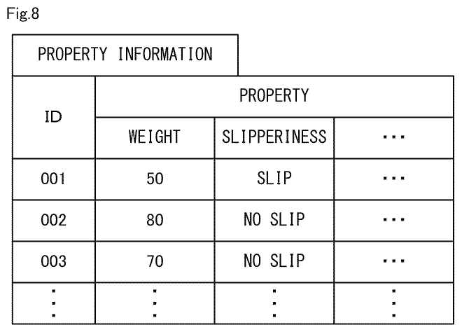

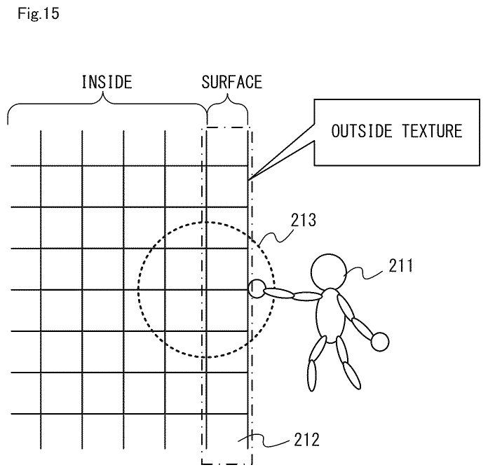

In the present embodiment, the density can take an integer value in the range from the lower limit value (e.g., 0) to the upper limit value (e.g., 255). In the present embodiment, the game system 1 determines the shape of a voxel object based on the density such that the proportion of the volume to be occupied by the voxel object in a voxel tends to be higher when the density value set for the voxel is higher and that the proportion tends to be lower when the density value is lower. Thus, the density is an index that affects the proportion of the volume to be occupied by the voxel object in the voxel. The density can also be said to be an index that represents the degree to which an object is included in the region defined by each voxel. For example, if the density is 0, there is no voxel object in the voxel, if the density is 255, the inside of the voxel is entirely the voxel object, and if the density is between 0 and 255, the inside of the voxel is occupied by the voxel object to the proportion that is determined based on the density value. Then, the shape of the mesh, e.g., the shape of the voxel object, can determined based on the density. Note however that the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

In other embodiments, the density may indicate either a state in which the voxel object occupies the entirety of the region within the voxel or a state in which no voxel object is included in the region within the voxel. For example, the density data may be data that can take only 0 or 1.

As shown in FIG. 7, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 7, in the present embodiment, the material data represents the identification information of the material (referred to as “material ID”). In the present embodiment, the game system 1 stores material information representing the property and the texture of the material for each material provided in the game (see FIG. 7). In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 7).

FIG. 8 is a diagram showing an example of property information representing properties of materials. As shown in FIG. 8, the game system 1 stores property information that associates each property ID with information that represents the content of the property represented by the property ID. A property of a material is a property of a voxel object for which the material is set in the game (which can be said to be a property that can affect the progress of the game), and it may be information such as weight or slipperiness shown in FIG. 8, for example. Note that a property of a material, as used herein, means not to include information regarding the appearance such as the texture, etc. For example, the following information may be set as properties of a material.
Temperature
Breakability (e.g., the number of times of impact impartation needed to break a voxel object)
Whether another object can be bonded to a voxel object
Amount of hit points to be regained by the player object when the player object breaks a voxel object
Amount of in-game currency to be gained by the player object when the player object breaks a voxel object

Note that there is no limitation on the specific content of the property to be set for a material. In other embodiments, information different from those listed above may be set as information that represents a property of a material.

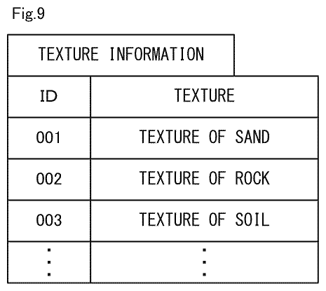

FIG. 9 is a diagram showing an example of texture information representing textures of materials. As shown in FIG. 9, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 7). In this case, the texture that is represented by the texture ID “002” associated with the material ID in the material information is applied to the voxel object corresponding to the voxel data (see arrow shown in FIG. 7).

As described above, in the present embodiment, the game system 1 separately manages the property and the texture of the material. Therefore, in the present embodiment, by setting a set of a property and a texture in the material information, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 7, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### 2-2. Mesh

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

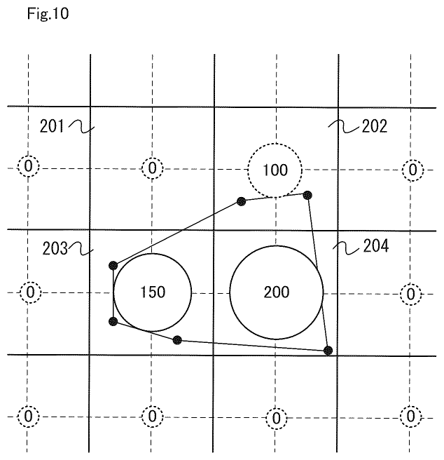

FIG. 10 is a diagram showing an example method for generating a mesh. Note that in FIG. 10, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for the voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 10, a voxel 201 and the other outer voxels have a density of 0, a voxel 202 has a density of 100, which is less than the reference value, and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 10, the density of the voxel 202 is less than the reference value, the voxel 202 is treated as being outside the voxel object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 10.

By generating a polygon mesh as described above, it is possible to generate a shape whose volume reflects the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference value are treated as being outside the voxel object in the present embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 11 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel corresponding to the voxel data (see FIG. 4).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the generation target voxel) among the voxels where the voxel object exists. Note that the generation target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. Note that the multiple types of material data are defined to be different from the primary material data and the sub-material data to be described below. When determining the texture to be mapped to each face of the mesh, the texture is determined based on various data (specifically, density data, multiple types of material data and ratio data) included in the voxel data of the generation target voxel. For example, when multiple types of materials are set for a generation target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

As described above, in the present embodiment, the game system 1 stores data representing a texture as material data that defines the color and/or pattern of the voxel object for each voxel. For a mesh that is generated based on voxel data, the game system 1 applies a texture represented by material data that is set for the voxel corresponding to the voxel data, thereby generating an image of the object. Then, since it is possible to render the color and/or pattern of the voxel object using the texture that is set for the voxel, it is possible to set the color and/or pattern of the voxel object for each voxel.

### 2-3. Process of Changing Appearance of Object

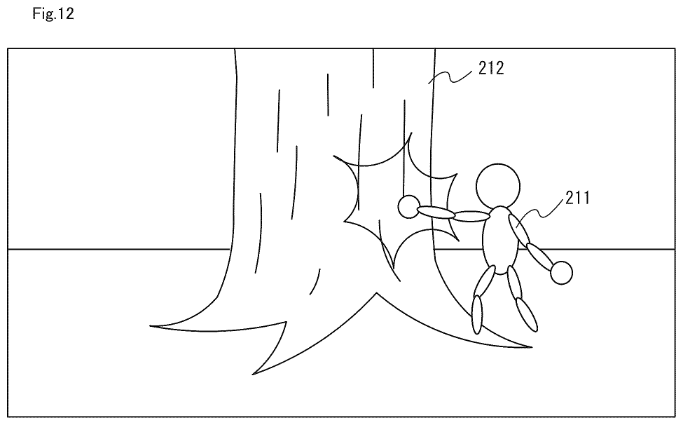

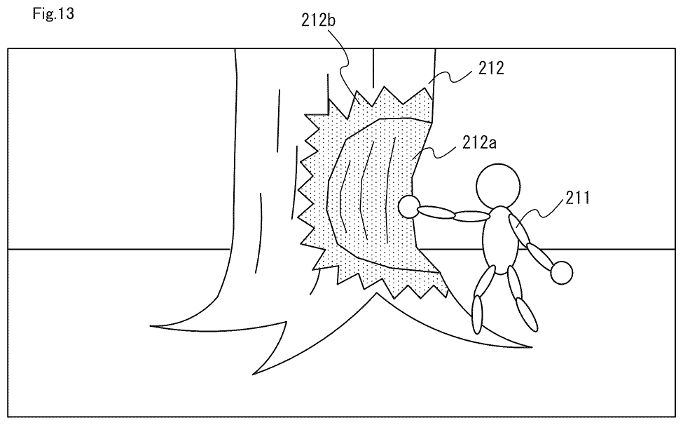

Next, referring to FIG. 12 to FIG. 20, the process of changing the appearance of the voxel object will be described. FIG. 12 is a view showing an example of how the player object performs a punch action against a tree object. FIG. 13 is a view showing an example of how a portion of the tree object is broken by the punch action by the player object. Note that a tree object 212 shown in FIG. 12 and FIG. 13 is a voxel object.

In the example shown in FIG. 12, the surface of the tree object 212 (specifically, the mesh of the tree object 212) is rendered using a texture that represents the appearance of the outer shell portion (e.g., the bark) of the tree object. Here, in the present embodiment, when a punch action is performed by the player object 211 against the tree object 212, a portion of the tree object 212 may be removed as shown in FIG. 13 under certain conditions. As a result, the inside of the tree object 212 (e.g., a portion inside the outer shell portion) is exposed. In this process, the exposed inner surface 212a is rendered using a texture that represents the appearance of the inside of the tree, as opposed to the surface of the outer shell portion of the tree object 212 (see FIG. 13). Moreover, in the present embodiment, a portion 212b of the surface of the tree object 212 surrounding the portion that has been removed by the punch action is also rendered using the texture that represents the inside of the tree, as is the surface 212a (see FIG. 13). The texture to be used for this portion 212b changes before and after a portion of the tree object 212 is removed.

As described above, in the present embodiment, when an event occurs for a voxel object (when a punch action is performed in the example described above), the game system 1 changes the appearance (specifically the texture) of the voxel object under certain conditions. Thus, it is possible to achieve such an expression that the inside of the voxel object is exposed. In the present embodiment, the outer shell portion on the surface of a voxel object can be made to appear thin by a method that will be described below. While the appearance of the tree object 212 shown in FIG. 12 and FIG. 13, for example, will be unnatural if the outer shell portion (bark) on the surface is expressed thick, according to the present embodiment, it is possible to express the outer shell portion to be thin, thereby making natural the appearance of the tree object 212 when the inside thereof is exposed.

### 2-3-1. Material Information Data for Which Another Material ID is Set

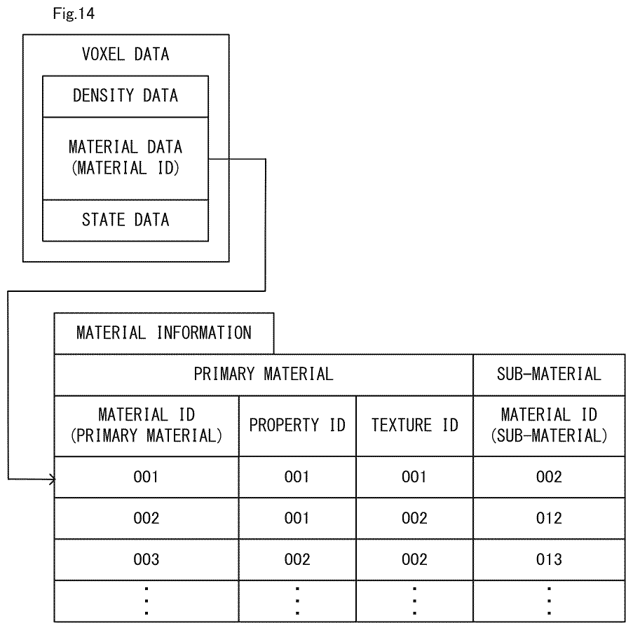

The game system 1 is configured so that when the texture of a voxel object is changed, the material data included in the voxel data can (selectively) specify the texture after change and the texture before change. Specifically, in the present embodiment, the game system 1 associates together two different materials, that are the primary material and the sub-material, in the material information. FIG. 14 is a diagram showing an example of the material information in which two different materials are associated with each other. In the present embodiment, as shown in FIG. 14, the material information includes, for the primary material, material ID (referred to as “primary material ID”), property ID and texture ID. These three IDs are similar to the three IDs included in the material information shown in FIG. 7. Here, the material information includes, as well as the three IDs relating to the primary material, a material ID representing a sub-material that is associated with the primary material (referred to as “sub-material ID”). Here, of the material data included in voxel data, the material data representing the primary material (representing a primary material ID) is referred to as “primary material data”, and the material data representing the sub-material (representing a sub-material ID) is referred to as “sub-material data”. The primary material is a material that corresponds to the texture before change, and the sub-material is a material that corresponds to the texture after change. That is, the primary material ID represented by the primary material data represents the material before change, and the sub-material ID represented by the sub-material data represents the material after change. Note that although the details will be described later, the material before change is a material that is used primarily to express the outer shell portion of a voxel object. The material after change is a material that is used primarily to express the inside of a voxel object. For example, when a voxel object represented by voxel data is a tree object described above, primary material data represents a material ID in the material information that is associated with a texture ID of a texture that represents the color and pattern expressing the bark of a tree (e.g., a texture that is dark brown and represents a pattern of countless grooves), and sub-material data that is set in the material setting data corresponding to the primary material data represents a material ID in the material information that is associated with a texture ID of a texture representing the color and pattern representing the inside of a tree (e.g., a texture that is light brown and represents a pattern of growth rings).

In the present embodiment, even when a sub-material is associated with a primary material, one property is set for one voxel data. For example, in the example shown in FIG. 14, while a material ID representing “002” as a sub-material is associated with a material ID representing “001” as a primary material, the material whose material ID is “001” and the material whose material ID is “002” are associated with the same property ID. Note however that in other embodiments, different properties may be set between the primary material and the sub-material. For example, in order to express such an object that is a rock inside and covered with grass on the outside, the primary material is set to grass while the sub-material is set to rock. Then, as a property representing the hardness, a soft property may be set for the primary material and a hard property for the sub-material.

Note that any data structure may be used for associating together two different material data before and after change. For example, in other embodiments, material data included in voxel data may represent both a material ID representing a primary material and a material ID representing a sub-material.

The game system 1 does not need to set material data that represents a primary material associated with a sub-material in the material information as described above for all the voxels in the virtual space. For example, of all the voxels where a voxel object exists, material data that represents a primary material associated with a sub-material in the material information may be set only for those voxels (referred to as “surface voxels”) that are located on the surface of the voxel object, while material data that represents a primary material not associated with a sub-material in the material information may be set for voxels (referred to as “inner voxels”) that are located inside the voxel object. In this process, material data included in voxel data of an inner voxel may represent a material that is associated with a texture ID of a texture that represents the color and pattern expressing the inside of the voxel object (e.g., for a tree object, a texture that is light brown and represents a pattern of growth rings). Note that for a certain voxel of which the density is equal to or greater than a reference value, for example, if there is a voxel for which a density less than the reference value is set among voxels adjacent to the certain voxel, it can be determined that the certain voxel is a surface voxel. On the other hand, for a certain voxel for which the density is equal to or greater than a reference value, if adjacent voxels all have a density equal to or greater than the reference value, it can be determined that the certain voxel is an inner voxel.

### 2-3-2. Specific Example of Changing Texture of Voxel Object

Next, a specific example of changing the texture of a voxel object will be described. In the present embodiment, when a change event occurs for a voxel object, the texture is changed for a portion where the change event occurs. A change event is an event that changes the appearance (specifically, the texture) of a voxel object. In the present embodiment, a change event occurs when a change condition is satisfied for a voxel object. In the present embodiment, when a removal event occurs in response to satisfaction of a removal condition for a predetermined voxel object (e.g., the tree object described above), the game system 1 determines that the change condition is satisfied.

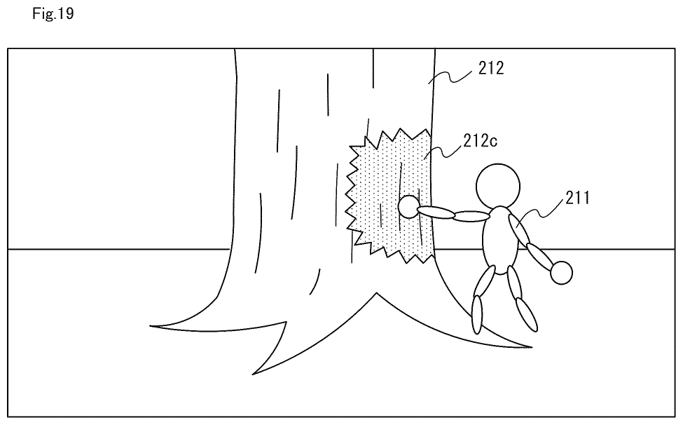

Note that there is no limitation on the content of the change condition, and it is not limited to the occurrence of a removal event. Although the details will be described later, in the present embodiment, not only when a removal event occurs but also when an impact-imparting event occurs for a predetermined voxel object, the game system 1 determined that a change event has occurred (see FIG. 19). Note that an impact-imparting event is an event in which an impact is imparted on a voxel object, e.g., an event in which a breaking action such as a punch action by the player object is performed against the voxel object, or an event in which another object collides with the voxel object.

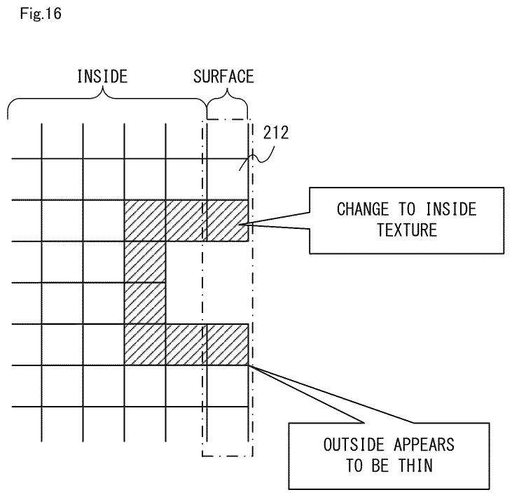

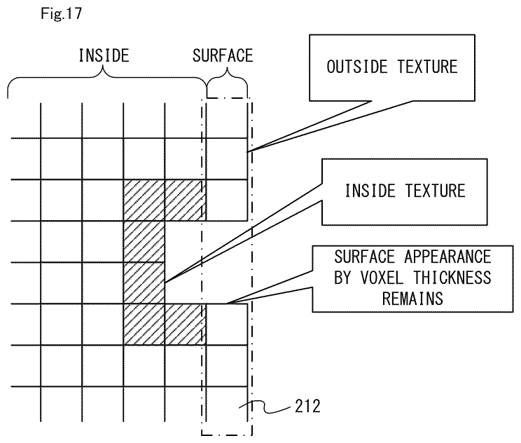

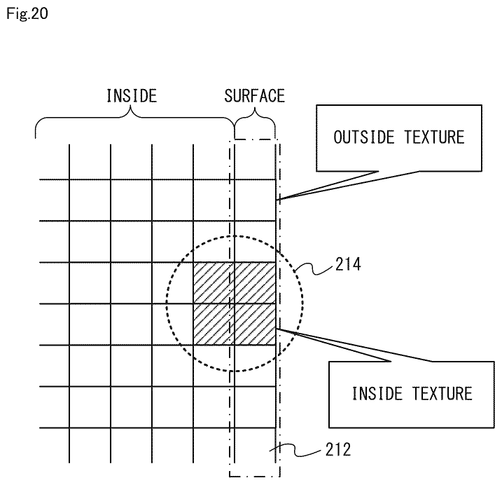

FIG. 15 is a view showing an example of the surface and the inside of a tree object. Note that FIG. 15 (this similarly applies also to FIG. 16, FIG. 17 and FIG. 20) shows a voxel object (specifically, the tree object 212) of which the mesh is generated by the same rule as when the mesh of the terrain object shown in FIG. 4 is generated for the purpose of showing the relationship between a voxel and a voxel object arranged in the voxel in an easy-to-understand manner. That is, the mesh of the voxel object shown in FIG. 15 is generated by the rule that “a cube is arranged at the position of a voxel if the density set for the voxel is greater than a predetermined value, whereas nothing is arranged at the position of the voxel if the density is less than or equal to the predetermined value”. Note that FIG. 15 shows a cross section of the tree object 212, wherein voxels of the rightmost column (voxels surrounded by one-dot-chain line in FIG. 15) are the surface voxels, and voxels on the left side thereof are the inner voxels.

FIG. 15 is a view showing a state before a portion of the tree object 212 is removed by a punch action by the player object 211. Here, in voxel data of each voxel of the tree object 212, primary material data in which sub-voxel data is set is set in the material information. In the state shown in FIG. 15, the game system 1 renders the mesh of the tree object 212 using a texture corresponding the primary material. Therefore, in the state shown in FIG. 15, the mesh of the tree object 212 has an appearance representing the outer shell portion (e.g., the bark) of the tree (see FIG. 12).

The dotted line area 213 shown in FIG. 15 shows a range (referred to as the “range of removal”) in which the tree object 212 is removed by the punch action by the player object 211. Note that in the example shown in the example shown in FIG. 15, it is assumed that the removal condition is satisfied by the punch action by the player object 211, triggering the removal event. The range of removal is determined based on the type of the impact-imparting event (e.g., the type of the action by the player object). For example, when an impact-imparting event is triggered by a punch action, the range of removal 213 is determined to be a spherical area centered at a position that is slightly forward of the position at which the punch by the player object 211 hits the tree object 212. Note that there is no limitation on the method for determining the range of removal, and it may be constant irrespective of the type of the impact-imparting event.

FIG. 16 is a view showing an example of a state in which a portion of the tree object has been removed from the state shown in FIG. 15. Note that in the example shown in FIG. 16, a portion of the tree object 212 corresponding to voxels (referred to as “removal target voxels”) that are included within the range of removal 213 shown in FIG. 15 is removed. Specifically, the game system 1 sets the density to 0 for the voxel data of the removal target voxels. In the state shown in FIG. 16, as a result of the removal of the removal target voxels of the tree object 212, a portion of the tree object 212 in the inner voxels is newly exposed.

Note that the example shown in FIG. 16 is described assuming that the tree object 212 is not removed for those voxels around the removal target voxels that are partially included in the range of removal 213. Note however that in practice, the tree object 212 may be partially removed for those voxels. Specifically, the game system 1 may subtract from the density for the voxels around the removal target voxels based on a predetermined rule. Note that there is no limitation on the rule. For example, the game system 1 may adjust the density for the voxels around the removal target voxels so as to generate a mesh along the periphery of the range of removal 213.

In the present embodiment, when a removal event of the tree object 212 occurs, the game system 1 causes a change event for voxels around the removal target voxel (voxels that are hatched in FIG. 16) of all the voxels where the tree object 212 exists. Note that voxels for which a change event occurs will be referred to as “change target voxels”. That is, in the present embodiment, when an object of the removal target voxels is removed, the game system 1 changes the texture to be rendered from a texture corresponding to the primary material to a texture corresponding to the sub-material for change target voxels around the removal target voxels, of all the voxels where the tree object 212 exists. Specifically, the game system 1 changes the material data set for the change target voxels from the primary material data to the sub-material data for the surface (specifically, the mesh) corresponding to the change target voxels. More specifically, the game system 1 updates the material data so that the material data set for the change target voxels represents the sub-material associated with the primary material in the material information, instead of the primary material represented by the material data. Then, rendering is done using a texture that is specified by the updated material data (see FIG. 16).

Note that the “surface corresponding to the change target voxels” is a mesh that is generated based on the voxel data of the change target voxels, and is a mesh that is influenced by the density indicated by the voxel data of the change target voxels, for example. Specifically, the “surface corresponding to the change target voxels” may be a mesh at least a portion of which is arranged within the change target voxels.

Note that the texture to be used in rendering is not changed for the material data of voxels, of the change target voxels, in which the sub-material data is not set in the material information. For example, as described above, for the inner voxels, a material corresponding to a texture that represents the color and pattern expressing the inside of the voxel object may be set as the primary material, while not setting the sub-material. Then, if a mesh is generated corresponding to the inner voxels by a removal event, rendering is done using a texture that represents the color and pattern expressing the inside of the voxel object. As a result, for a mesh corresponding to the change target voxels including both inner voxels and surface voxels, rendering is done using a texture that represents the color and pattern expressing the inside of the voxel object.

Here, in other embodiments, another possible method is to specify only inner voxels of the tree object 212 as change target voxels, while not specifying surface voxels as change target voxels (e.g., only for a mesh corresponding to inner voxels, rendering is done using a texture that represents the color and pattern expressing the inside of the tree object 212). FIG. 17 is a view showing an example of the surface and the inside of a tree object in a case where surface voxels are not specified as change target voxels. The example shown in FIG. 17 shows a case where for voxel data of surface voxels, rendering is done using a texture that represents the color and pattern of the outer shell of the tree object as before the removal, without changing the texture (as opposed to the present embodiment). In such a case, for a portion of a mesh that corresponds to the surface of surface voxels, of the surface that has been newly exposed by the removal, rendering is done using a texture that represents the color and pattern of the outer shell of the tree object, thereby resulting in an appearance representing the bark of the tree. A portion having a thickness of one voxel, of the surface that has been newly exposed by the removal, will have an appearance representing the bark, and the thickness of the bark will be equal to one voxel and it will not be possible to achieve an expression where the thickness of the bark is thinner than the thickness of a voxel.

In contrast, in the present embodiment, not only for a mesh that represents the surface newly exposed by the removal event, but also for a mesh that has not changed since before the removal event, the game system 1 renders using a texture corresponding to the sub-material data (see FIG. 16). That is, the game system 1 sets the texture of a mesh that is generated based on voxel data for change target voxels and that has not changed before and after the change event, based on the sub-material data set for the change target voxels. Then, for an area around the removed portion, of the mesh corresponding to the surface voxel of the tree object 212, although the position of the mesh has not changed since before the removal, it changes to an appearance that represents the inside of the tree (see FIG. 13). Thus, since the area around the removed portion takes an appearance as if a very thin surface had been stripped off, the tree object can appear as if the outer shell portion of the tree were formed to be thin, thus realizing a natural appearance.

Note that in the present embodiment, if textures that are set for the two adjacent voxels are different from each other, rendering is done so that the boundary between areas where the two different textures are rendered is jagged (see FIG. 13). Then, it is possible to realistically express how a portion of the bark is stripped off as a result of removing a portion of the tree object 212 by the impact-imparting event. Note however that there is no limitation on the method for generating a mesh or the rendering method, and there is no limitation on how the boundary is formed between areas where the two different textures are rendered. For example, the game system 1 may render so that the boundary is formed along the periphery of the range of removal 213, or may blur the boundary.

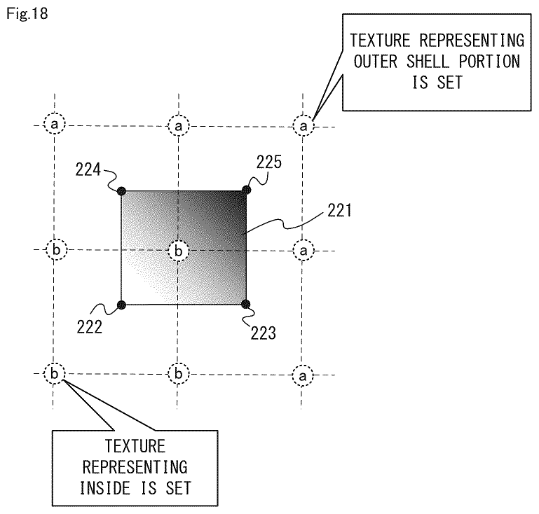

FIG. 18 is a view showing an example of a mesh at the boundary between areas where two different textures are rendered. Note that while FIG. 18 two-dimensionally expresses voxels and meshes so that the drawing and the description are easy-to-understand, as does FIG. 10, a three-dimensional mesh 221 is generated in practice based on voxels in a three-dimensional space. The mesh 221 is a mesh that is generated based on voxel data of surface voxels (which can also be said to be a mesh of which the position does not change before and after the change event).

In FIG. 18, a circle labelled “a” or “b” indicates the center position of the voxel. Specifically, a circle labelled “a” is the center position of a voxel for which a material is set that is associated with the primary texture (e.g., a texture that represents the color and pattern expressing the outer shell of a tree, for example), and a circle labelled “b” is the center position of a voxel for which a material is set that is associated with the sub-texture (e.g., a texture that represents the color and pattern expressing the inside of a tree). A vertex 222 of the vertices of the mesh 221 is a vertex that is set between voxels for which a material corresponding to the sub-texture is set (e.g., that is set based on voxel data of these voxels). Vertices 223 to 225 of the vertices of a mesh 211 are each a vertex that is set between a voxel for which a material corresponding to the primary texture is set and a voxel for which a material corresponding to the sub-texture is set (e.g., that is set based on voxel data of voxels for which the material corresponding to the primary texture is set and voxel data of voxels for which the material corresponding to the sub-texture is set). Note however that for the vertex 225, the proportion of the material corresponding to the primary texture, of the materials set for the corresponding voxels, is higher than the vertices 223 and 224. Specifically, for the vertices 223 and 224, the proportion between the material corresponding to the primary texture and the material corresponding to the sub-texture set for the corresponding voxels is fifty-fifty (in FIG. 18, two of the former and two of the latter), whereas for the vertex 225, there is more of the material corresponding to the primary texture than the material corresponding to the sub-texture, of the materials set for the corresponding voxels (in FIG. 18, there are three voxels for which the material corresponding to the primary texture is set and there is one voxel for which the material corresponding to the sub-texture is set).

As shown in FIG. 18, for a mesh that is arranged at a position such that textures set for the surrounding voxels are different from each other (e.g., a mesh that is generated based on voxel data of voxels for which different textures are set), rendering may be done so that there is a gradation from one texture to the other texture by means of interpolation. Note that in the example shown in FIG. 18, it is assumed that the sub-texture is white and the primary texture is black. Then, it is possible to smoothen the change of the color and/or pattern at the boundary between two different textures, and it is possible to make the appearance of the object more natural.

As described above, in the present embodiment, the game system 1 generates an image of the voxel object by rendering a mesh that is generated based on voxel data of change target voxels and voxel data of voxels different from the change target voxels (e.g., a mesh to be the boundary described above) so that there is a gradation from the primary texture represented by the primary material data to the sub-texture represented by the sub-material data. It can also be said that the game system 1 renders a mesh of at least a portion of the periphery of the mesh of the exposed portion of the voxel object that is exposed by the removal event so that there is a gradation from the color and/or pattern represented by the primary texture to the color and/or pattern represented by the sub-texture. Thus, it is possible to make the appearance of the object more natural.

As described above, in the present embodiment, when a removal event in which at least a portion of the voxel object is removed occurs, the game system 1 updates the voxel data of removal target voxels for which the removal event has occurred so that at least a portion of the voxel object in the removal target voxels is removed. Then, the game system 1 determines that a change event has occurred in voxels around the removal target voxel (more specifically, voxels around the removal target voxels where the voxel object exists) (specifically, performs rendering using a sub-texture that is set for the surrounding voxels). Then, when a portion of the voxel object is removed and the inside thereof is exposed, it is possible to express a thin outer shell portion of the voxel object.

Note that the change target voxels do not need to be all of the voxels around the removal target voxels. For example, as described above, only one material data (e.g., primary material data representing the primary material used for expressing the inside of the voxel object) may be set for the inner voxels, and material data representing the primary material associated with the sub-material in the material information may be set for the surface voxels. Then, for inner voxels of all the voxels around the removal target voxels, a texture that represents the inside of the voxel object is applied without changing the texture, and the game system 1 may specify, as removal target voxels, only surface voxels of all the voxels around the removal target voxels. This can also achieve similar advantageous effects to those of the present embodiment.

Note that the game system 1 may execute the removal of the voxel object by the removal event together with the change of the appearance of the voxels by the change event. That is, when a removal event occurs, the game system 1 may execute the removal process of removing (specifically, the process of setting the density to 0) the removal target voxels in the range of removal, and also execute the change process (specifically, the process of changing the material data used in rendering to the sub-material data) for the change target voxels within a range that is slightly larger than the range of removal. Then, it is possible to achieve the change of appearance of the voxel object in response to the removal event with a good response.

The description has been made for an example of a case where a change event occurs triggered by a removal event. Here, the change condition of the occurrence of a change event is not limited to the occurrence of a removal event. For example, also when a removal event does not occur by an impact-imparting event, the game system 1 may cause a change event to occur by the impact-imparting event.

FIG. 19 is a view showing how a change event occurs by an impact-imparting event. In the example shown in FIG. 19, the change condition for the tree object 212 is that an impact-imparting event occur against the tree object 212. Then, in response to the occurrence of the impact-imparting event, the game system 1 causes a change event for a range that is in accordance with the impact-imparting event. That is, the game system 1 changes the texture to be used in rendering from the primary texture to the sub-texture for a portion of the mesh of the tree object 212 that is within this range. As a result, as shown in FIG. 19, the portion within this range has an appearance representing the inside of the tree.

Note that the “range in accordance with the impact-imparting event” is the range of influence of the impact-imparting event. For example, when an impact-imparting event occurs caused by a punch action by the player object 211, the “range in accordance with the impact-imparting event” is a predetermined range including the position at which the punch of the player object 211 hits the terrain object.

FIG. 20 is a view showing an example of the surface and the inside of the tree object when the texture is changed without removing the tree object. The dotted line area 214 shown in FIG. 20 is the range in accordance with the impact-imparting event. In the present embodiment, when a change event occurs caused by an impact-imparting event, the game system 1 determines voxels (voxels hatched in FIG. 20), of all the surface voxels, that are included in the range in accordance with the impact-imparting event as change target voxels. For a surface (specifically, a mesh) 212c corresponding to the change target voxels, the game system 1 updates the material data set for the change target voxels from the primary material data to the sub-material data, and performs rendering using the sub-texture specified by the sub-material data. Thus, of the mesh of the tree object 212, a portion within the range in accordance with the impact-imparting event changes to the appearance representing the inside of the tree (although the position of the mesh does not change by the removal) (see FIG. 19). Then, it is possible to make it look like a thin outer shell portion (e.g., the bark) has been stripped off by an impact-imparting event, and the appearance of the tree object 212 can be made a natural appearance with a thin outer shell portion.

Note that in the case described above, the method for determining the change target voxels may be any method based on the range in accordance with the impact-imparting event. For example, in other embodiments, the game system 1 may determine, as the change target voxels, voxels included in the range in accordance with the impact-imparting event and voxels adjacent thereto, of all the surface voxels.

As described above, in the present embodiment, when an impact-imparting event in which an impact is imparted on the voxel object occurs, the game system 1 determines that a change event has occurred for voxels that are at positions based on the position at which the impact-imparting event has occurred (specifically, positions that are included in the range in accordance with the impact-imparting event) (specifically, the game system 1 performs rendering using the sub-texture set for the voxels). Then, when an impact-imparting event is performed against the voxel object, it is possible to make it look like an outer shell portion of the voxel object has been stripped off (even if a portion of the voxel object is not removed).

When the texture is changed by a change event in response to an impact-imparting event, in the present embodiment, the game system 1 does not change the position of the mesh of the voxel object. Note however that in other embodiments, the game system 1 may change the position of the mesh in the case described above. For example, the game system 1 may change the position of the mesh so that the mesh for which the change event occurs slightly moves toward the inside of the voxel object.

Note that the game system 1 may execute both the process of causing the change event in response to the removal event and the process of causing the change event in response to the impact-imparting event. That is, the change condition may be that one of “a removal event has occurred” or “an impact-imparting event has occurred” is satisfied. In the present embodiment, the game system 1 causes the change event as follows.

In the present embodiment, when the impact-imparting event is performed, the game system 1 determines whether the change condition is satisfied and whether the removal condition is satisfied. Here, in the present embodiment, the voxel object has a strength that is set for each voxel, and the impact-imparting event also has a strength that is depending on the type of the impact-imparting event. For example, the type of the impact-imparting event is determined so as to vary depending on the type of the action performed in the impact-imparting event, or the type of the object that has collided on the voxel object in the impact-imparting event. The game system 1 determines whether the change condition is satisfied and whether the removal condition is satisfied based on these strengths. Note that in the present embodiment, the strength of the voxel object is set as one of the properties of the material described above, for example. That is, it can be said that the property ID is data representing the strength of the voxel object. In the present embodiment, it is assumed that the strength can take any integral value from 1 to the upper limit value.

In the present embodiment, the removal condition is set in accordance with the relationship between strength A of the breaker side (e.g., the impact-imparting event) and strength B of the broken side (e.g., the voxel object). Specifically, the game system 1 determines the removal condition as shown in (a) to (c) below.
(a) when strength A of the breaker side is equal to or greater than strength B of the broken side (when A≥B), it is determined that the removal condition is satisfied.
(b) when the value obtained by adding 1 to strength A of the breaker side is equal to strength B of the broken side (when A+1=B), a damage in accordance with the type of the impact-imparting event is given to the voxel object, and it is determined that the removal condition is satisfied when the damage of the voxel object becomes equal to or greater than the reference value.
(c) when the value obtained by adding 1 to strength A of the breaker side is less than strength B of the broken side (when A+1<B), no damage is given to the voxel object (as a result, the removal condition is not satisfied).

Note that in the present embodiment, the damage of the voxel object is managed for each voxel. That is, the game system 1 stores data representing the value of the damage described above for each voxel as the state data included in the voxel data.

As described above, in the present embodiment, when strength A of the breaker side is equal to or greater than strength B of the broken side ((a) above), the removal condition is satisfied as a result of the occurrence of the impact-imparting event. When strength A of the breaker side is slightly smaller than strength B of the broken side ((b) above), the removal condition is satisfied after the impact-imparting event occurs a number of times at the same position (e.g., the same voxel) of the voxel object. That is, in such a case, in response to the impact-imparting event having occurred a certain number of times at a certain portion of the voxel object, that portion is removed. When strength A of the breaker side is significantly smaller than strength B of the broken side ((c) above), the removal condition is not satisfied even if the impact-imparting event occurs.

The game system 1 determines the removal condition for each voxel. Specifically, when an impact-imparting event is performed, for each voxel in the range in accordance with the impact-imparting event, the removal condition is determined based on the strength of the impact-imparting event and the strength set for the voxel.

Note that in the case (a) above, since the removal condition is satisfied, the game system 1 determines that the change condition is also satisfied. In such a case, in response to satisfaction of the removal condition, a portion of the voxel object is removed, and the texture is changed for a portion of the voxel object (see FIG. 13). In the case (b) above, the game system 1 determines that the change condition is satisfied even when the removal condition is not satisfied. In such a case, while the voxel object is not removed, the process of changing the texture for a portion of the voxel object is executed (see FIG. 19). In the case (c) above, the game system 1 determines that the change condition is not satisfied.

As described above, in the present embodiment, in the case (b) above, in response to the impact-imparting event occurring for the first time, the voxel object is not removed, but the texture of the voxel object is changed for the range in accordance with the impact-imparting event (see FIG. 19). Then, in response to the impact-imparting event occurring thereafter for the second and subsequent times, the voxel object is removed, and the texture of the voxel object is changed for a portion around the removed portion (see FIG. 13). Note that in other embodiments, in the case (b) above, instead of determining that the change condition is satisfied by the impact-imparting event for the first time, the game system 1 may determine that the change condition is satisfied when the damage of the voxel object becomes equal to or greater than the reference value. Note that the reference value used for determining the change condition is set to a value that is smaller than the reference value used for determining the removal condition. That is, the game system 1 sets the number of times of the impact-imparting event for the change condition to be satisfied to be smaller than the number of times of the impact-imparting event for the removal condition to be satisfied.

As described above, in the present embodiment, when the impact-imparting event has occurred a first number of times (e.g., once) on the voxel object, the game system 1 determines that the change event has occurred for voxels of the voxel object in the range in accordance with the impact-imparting event. When the impact-imparting event occurs a second number of times (e.g., twice or more), which is larger than the first number of times, on the voxel object, the game system 1 updates the voxel data for removal target voxels of the voxel object that are at positions based on the range in accordance with the impact-imparting event so that a portion of the voxel object in the removal target voxels is removed. When the impact-imparting event occurs a second number of times on the voxel object, the game system 1 determines that the change event has occurred for at least some voxels, of all the voxel around the removal target voxels. Then, it is possible to first make it look like a thin outer shell portion of the voxel object has been stripped off by the impact-imparting event, and it is possible to express the removal of a portion of the voxel object by additional impact-imparting events thereafter (the outer shell portion is further stripped off around the removed portion).

Note that the content of the removal condition, the content of the change condition, the range of the removal event and the range of the change event may be any content and range, and they are not limited to those described above. For example, the range of the removal event and the range of the change event may be set for each type of the impact-imparting event.

In the present embodiment, in response to the change event, the game system 1 changes the appearance (specifically, the texture) of the voxel object while not changing the property of the voxel object. That is, in the present embodiment, the material data is associated with the property data that defines the property of the object for each voxel, and the property data associated with the primary material data and the property data associated with the sub-material data are the same. The game system 1 sets the property of the object based on the property data. More specifically, the game system 1 sets the property of the voxel object based on the property data that is set for the voxel object, independent of whether the primary texture or the sub-texture is applied to the mesh of the voxel object. Then, it is possible to set the property of the voxel object without being influenced by the appearance of the voxel object.
2-3-3. Example Where Three or More Different Materials are Set

When a sub-material is associated with a primary material that is set for a certain voxel, still another material may be associated with the sub-material. For example, in the example of the material information shown in FIG. 14, a sub-material whose material ID is “002” is associated with a primary material whose material ID is “001”, and a sub-material whose material ID is “012” is associated with a material whose material ID is “002” as the primary material. Thus, when the change event first occurs for the voxel object for which voxel data including first material data (e.g., material data representing “001”) is set, the game system 1 renders the mesh corresponding to the change target voxels using second material data (e.g., material data representing “002”) instead of first material data. In such a case, voxel data of the change target voxels is updated so as to include the second material data instead of the first material data. Then, when the change event occurs for the voxel object for the next time, the game system 1 renders the mesh corresponding to the change target voxel using the third material data (e.g., material data representing “012”) instead of the second material data. In such a case, the voxel data of the change target voxels is updated so as to include the third material data instead of the second material data.

As described above, in the present embodiment, in response to the change event occurring for the first time, the game system 1 sets the color and/or pattern (specifically, the texture) of the mesh of the voxel object generated based on voxel data for the change target voxels based on the second material data that is set for the change target voxels at the position at which the change event of for the first time has occurred. In response to the change event occurring for the second time for the change target voxels, when the third material data is associated with the second material data that is set for the change target voxels at the position at which the change event for the second time has occurred, the color and/or pattern of the mesh of the voxel object generated based on voxel data for the change target voxels are set based on the third material data. Thus, in the material information, if one other material to be associated with a certain material is allowed to be set, it is possible to set one yet another material associated with the other material. Therefore, by further causing the change event in a portion of the mesh rendered based on the second material data, for example, it is possible to express a voxel object having three layers having different appearances. Note that in a manner similar to that described above, it is possible to express a voxel object having four layers or more having different appearances. Then, in the present embodiment, since such a multi-layer expression can be realized without setting a large number of material data for each voxel data, an increase in the amount of memory that is necessary can be made very small even if the number of voxel data becomes large. Note that the ability to keep an increase in the amount of memory that is necessary very small is similar also in the case of two layers.

### 3. Specific Example of Process Performed on Game System

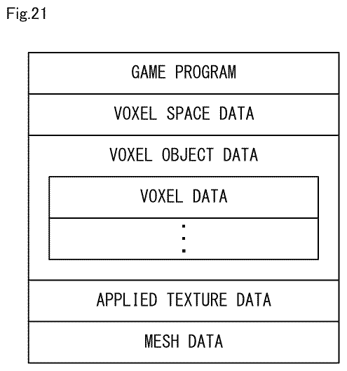

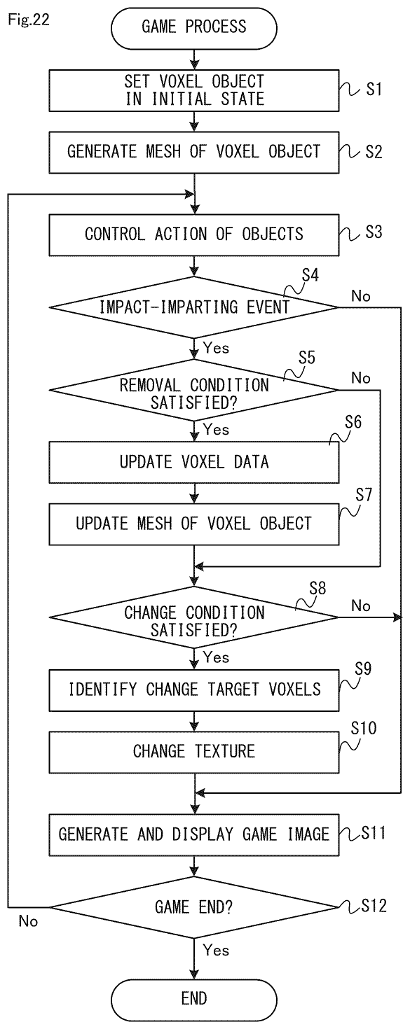

Next, referring to FIG. 21 and FIG. 22, a specific example of an information process on the game system 1 will be described.

FIG. 21 is a diagram showing an example of various data used for information processes to be performed on the game system 1. As shown in FIG. 21, the game system 1 stores a game program, voxel space data, voxel object data and mesh data. The game program and the voxel space data are data stored in the game system 1 in advance before executing the game process. The game program and the voxel space data are stored in a storage medium attached to the slot 23 of the main body apparatus 2, for example. The voxel object data and the mesh data are data that are generated while the game process is executed. These data are stored in a DRAM 85 of the main body apparatus 2, for example.

The game program is a game program for executing a game process of the present embodiment (specifically, the game process shown in FIG. 22).

The voxel space data is data that defines a voxel space to be set in the game space. Specifically, voxel space data represents the length of one side of the voxel, and the direction of each edge of the voxel in the game space. Where the voxel space is set only in a partial area of the game space, the voxel space data may include data representing the position and the size of the space in which a voxel is set (e.g., the voxel space) (e.g., data representing a range in the game space where the voxel is set).

The voxel object data is data that represents a voxel object (e.g., a tree object) arranged in the game space. Specifically, the voxel object data includes voxel data for each unit area within an area that is a part or whole of the game space.

The mesh data is data representing a mesh that is set for the voxel object arranged in the game space. The mesh data includes data representing the position of each vertex in the mesh, for example.

Note that as data stored in advance on the game system 1 before executing the game process, the game system 1 stores, in addition to the data shown in FIG. 21, data of the material information, the property information and the texture information, and data related to various characters to appear in the game, etc.

FIG. 22 is a flow chart showing an example of the flow of the game process to be executed by the game system 1. The game process shown in FIG. 22 is started in response to the player giving an instruction to start the game during execution of the game program, for example.

Note that in the present embodiment, it is assumed that the processor 81 of the main body apparatus 2 executes the processes of the steps shown in FIG. 22 by executing the game program stored in the game system 1. Note however that in other embodiments, some of the processes of the steps may be executed by another processor (e.g., a dedicated circuit) different from the processor 81. When the game system 1 can communicate with another information processing apparatus (e.g., a server), some of the processes of the steps shown in FIG. 22 may be executed on the other information processing apparatus. The processes of the steps shown in FIG. 22 are merely illustrative, and the order of steps to be performed may be switched around or other processes may be executed in addition to (or instead of) the processes of the steps, as long as similar results are obtained.

The processor 81 executes the processes of the steps shown in FIG. 22 using a memory (e.g., the DRAM 85). That is, the processor 81 stores information (in other words, data) obtained in each process step in the memory, and when the information is used in a subsequent process step, the information is read out from the memory and used.

In step S1 shown in FIG. 22, the processor 81 sets a voxel object in an initial state in the game space. Specifically, the processor 81 obtains voxel data representing the arrangement of the voxel object in the initial state, and stores (in other words, writes) a part or whole of the obtained voxel data in the DRAM 85 as voxel object data. Thus, data representing the density for generating a mesh for each voxel, data representing the texture to be applied to the mesh, data representing the property of the voxel object, etc., are obtained by the processor 81. Note that voxel data representing the arrangement of the voxel object in the initial state is stored in a storage medium attached to the slot 23 of the main body apparatus 2, for example. The process of step S2 is executed, following step S1.

Note that voxel data to be written in the DRAM 85 as voxel object data may be voxel data in a partial range used for generating a game image, of all the voxel data for the entire range of the game space. The processor 81 may generate an image of an object using voxel data only for a partial range (e.g., a ranged within a predetermined distance from the position of the virtual camera) of the game space, for example. Then, voxel object data may include voxel data within such a range. When voxel data for a partial range of the game space is written, a process similar to step S1 described above is executed at an appropriate point in time (e.g., at a point in time when the position of the virtual camera has moved a predetermined distance or more) during execution of a series of processes of steps S3 to S12 to be described below.

In step S2, the processor 81 generates a mesh for the voxel object. The mesh is generated according to the method described in “[2-2. Mesh]” above. Here, the processor 81 generates the mesh based on the voxel object data stored in the DRAM 85, and stores the generated mesh as mesh data in the DRAM 85. Through the process of step S2, voxel object in which the texture to be applied to the mesh and the property are set is constructed in the game space. The game starts after step S2 described above, and a series of processes of steps S3 to S12 is repeatedly executed during the game.

In step S3, the processor 81 controls the action of various objects (e.g., the player object and enemy objects) appearing in the game space. For example, the processor 81 controls the action of the player object based on the operation data received from the controller 3 or 4, and controls the action of enemy objects based on an algorithm predetermined in the game program. The process of step S4 is executed, following step S3.

In step S4, the processor 81 determines whether the impact-imparting event has occurred as a result of step S3 described above. If the determination result from step S4 is affirmative, the process of step S5 is executed. On the other hand, if the determination result from step S4 is negative, the process of step S11 to be described below is executed, skipping a series of processes of steps S5 to S10.

In step S5, the processor 81 determines whether the removal condition is satisfied as a result of step S3 described above. Note that since the determination of the removal condition is made for each voxel as described above, in the determination of step S3, the determination result is affirmative if the removal condition is satisfied for at least one voxel. If the determination result from step S5 is affirmative, the process of step S6 is executed. On the other hand, if the determination result from step S5 is negative, the process of step S8 is executed, skipping a series of processes of steps S6 and S7.

In step S6, the processor 81 updates voxel data in the voxel object data stored in the DRAM 85 so as to remove a portion of the voxel object. Specifically, the processor 81 removes a portion of the voxel object by the method described in “[2-3-2. Specific example of changing texture of voxel object]” above. The process of step S7 is executed, following step S6.

In step S7, the processor 81 updates the mesh for the voxel object for which the voxel data has been updated in step S6. That is, the processor 81 generates a mesh of the voxel object based on the voxel object data that has been updated in step S6. Then, the mesh of the voxel object can be changed dynamically during the game. Note that the processor 81 updates the mesh data stored in the DRAM 85 so as to represent the newly generated mesh. The process of step S8 is executed, following step S7.

In step S8, the processor 81 determines whether the change condition is satisfied as a result of step S3 described above. If the determination result from step S8 is affirmative, the process of step S9 is executed. On the other hand, if the determination result from step S8 is negative, the process of step S11 is executed, skipping the processes of steps S9 and S10.

In step S9, the processor 81 identifies the change target voxels for which the change event occurs. Specifically, when the change condition is satisfied as a result of the occurrence of the removal event, the processor 81 identifies voxels around the removal target voxels as change target voxels. When the change condition is satisfied as a result of the impact-imparting event, the processor 81 identifies voxels in the range in accordance with the impact-imparting event as change target voxels. The process of step S10 is executed, following step S9.

In step S10, the processor 81 changes the texture to be used for rendering the mesh from the primary texture to the sub-texture for the change target voxels identified in step S9. Specifically, the processor 81 changes the material data of the voxel data of the change target voxels so as to represent the sub-material, not the primary material. That is, the sub-texture corresponding to the sub-material will thereafter be the texture to be used for rendering the mesh. The processor 81 updates the voxel object data stored in the DRAM 85 so as to represent the voxel data that has been changed as described above. The process of step S11 is executed, following step S10.

In step S11, the processor 81 generates a game image representing the game space and displays the game image on the display device. Specifically, the processor 81 generates a game image representing the game space including the voxel object and other objects (e.g., the player object and enemy objects). Note that the image of the voxel object is generated according to the method described in “[2-2. Mesh]” above by using the voxel object data and the mesh data stored in the DRAM 85. Then, for voxel data for which two different material data are set, the processor 81 generates a game image (specifically, renders the mesh) by using a texture that is identified by the material data included in the voxel data. Therefore, when the texture data to be applied is changed in the process of step S10, the texture to be used in rendering will be changed, and the appearance of the voxel object will be changed. The processor 81 displays the game image generated as described above on the display device. Note that during the game, the process of step S11 is repeated at a rate of once per a predetermined amount of time (e.g., one frame period). The process of step S12 is executed, following step S11.

In step S12, the processor 81 determines whether or not to end the game. For example, the processor 81 determines whether an instruction to end the game has been given by the user. If the determination result from step S12 is negative, the process of step S3 is executed again. Thereafter, a series of processes of steps S3 to S12 is repeatedly executed until it is determined to end the game in step S12. On the other hand, if the determination result from step S12 is affirmative, the processor 81 ends the game process shown in FIG. 22.

### 4. Functions/Effects and Variations of Present Embodiment

As described above, in the embodiment described above, an information processing system (specifically, the game system 1) is configured to include the following units.
an object generator (step S2) configured to generate a mesh of an object (e.g., a voxel object) in a virtual space based on voxel data for each voxel defined in a voxel space that is set in the virtual space;
a material data obtainer (step S1) configured to obtain first material data (e.g., primary material data) and second material data (e.g., sub-material data) as material data that defines a color and/or pattern (e.g., a texture) of the object for each voxel;
an appearance setter (step S10) configured to (a) before a change event that changes an appearance of the object occurs, set a color and/or pattern of a mesh of the object based on the first material data, and (b) after the change event occurs, when the second material data is associated with the first material data, set, based on the second material data, a color and/or pattern of a mesh that is generated based on voxel data for change target voxels and that corresponds to a portion of a surface of the object; and
an image outputter (step S11) configured to output an image of the mesh of the object in the virtual space to a display device.

With the configuration described above, for a portion of the object where the change event occurs, the color and/or pattern of the mesh changes because of the change event, and it is possible to make it look like a thin outer shell portion of the object has been stripped off by the change event. Thus, it is possible to express a thin outer shell portion of the object.

In the embodiment described above, it can also be said that an information processing system (specifically, the game system 1) is configured to include the following units.
an object generator (step S2) configured to generate a mesh of an object in a virtual space based on voxel data for each voxel defined in a voxel space that is set in the virtual space;
a renderer (step S11) configured to render a first color and/or pattern (e.g., a color and/or pattern representing an outer shell portion of the object) on a mesh of the object before a removal event that removes a portion of the object occurs; and
an image outputter (step S11) configured to output an image of the mesh of the object in the virtual space on a display device.

After the removal event has occurred, the voxel generator updates the voxel data so that a portion of the object is removed (step S6). The renderer configured to render a second color and/or pattern (e.g., a color and/or pattern representing the inside of the object) different from the first color and/or pattern on a mesh of an exposed portion of the object that is exposed as a result of the removal and a mesh for at least a portion around the mesh of the exposed portion (see FIG. 13).

With the configuration described above, when a portion of the object is removed, a color and/or pattern for the inside of the object is rendered on the mesh around the exposed portion that is exposed as a result of the removal, and it is possible to express a thin outer shell portion of the object.

Note that with the configuration described above, material data is only required to include data that defines the color and/or pattern of the object, and does not need to include data representing the property of the object.

In the embodiment described above, the game system 1 sets a color and/or pattern based on the sub-material data (e.g., renders the color and/or pattern of the inside of the object) for at least one mesh that is generated based on voxel data related to change target voxels and whose position has not changed before and after the change event (which can also be said to be a removal event when the change event occurs based on a removal event). Then, the boundary between the area where the color and/or pattern for the outside is rendered and the area where the color and/or pattern for the inside is rendered will be located on the mesh that does not change before and after the change event. Thus, it is possible to express a thin outer shell portion of the object. Since there is no need to unnecessarily change the mesh, it is possible to reduce the process load for changing the appearance of the object.

In the embodiment described above, a tree object has been described as an example of a voxel object whose appearance varies between the outer shell and the inside. Here, in other embodiments, a voxel object whose appearance varies between the outer shell and the inside may be any object in the virtual space. For example, the voxel object may be a terrain object, or may be an object that can move in the virtual space such as the player object, an enemy object, or a vehicle object on which the player object, or the like, can ride. Note that the game system 1 may arrange, in the virtual space, both of a voxel object whose appearance varies between the outer shell and the inside and a voxel object whose appearance does not vary between the outer shell and the inside.

Note that in other embodiments, the information processing system does not need to include one or more of the components of the embodiment described above and does not need to execute one or more of the processes that are executed in the embodiment described above. For example, in order to realize a specific one of the advantageous effects of the embodiment described above, the information processing system may include a component or components for realizing the specific advantageous effect and execute a process or processes for realizing the specific advantageous effect, and the game system does not need to include other components and does not need to execute other processes.

The embodiment described above can be used as, for example, a game system or a game program, with the aim of, for example, expressing a thin outer shell portion of an object, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing comprising:
generating a mesh of an object in a virtual space based on voxel data for each voxel defined in a voxel space that is set in the virtual space;
obtaining first material data and second material data as material data that defines a color and/or pattern of the object defined for each voxel;
(a) before a change event that changes an appearance of the object occurs, setting a color and/or pattern of a mesh of the object based on the first material data, and (b) after the change event occurs, when the second material data is associated with the first material data that is set for change target voxels, which are voxels at a position at which the change event has occurred, setting, based on the second material data, a color and/or pattern of a mesh that is generated based on voxel data related to the change target voxels and that corresponds to a portion of a surface of the object; and
outputting an image of the mesh of the object in the virtual space on a display device.

2. The non-transitory computer-readable storage medium according to claim 1, wherein:
when a removal event in which at least a portion of the object is removed occurs, the voxel data related to removal target voxels where the removal event has occurred is updated so that at least a portion of the object is removed in the removal target voxels; and
the information processing further comprises: determining that the change event has occurred in at least one of voxels around the removal target voxels.

3. The non-transitory computer-readable storage medium according to claim 2, wherein a color and/or pattern of at least one mesh is set based on the second material data, wherein the at least one mesh is generated based on voxel data related to the change target voxels and a position of the at least one mesh has not changed before and after the removal event.

4. The non-transitory computer-readable storage medium according to claim 1, wherein the information processing further comprises: when an impact-imparting event in which an impact is imparted on the object occurs, determining that the change event has occurred for voxels that are at positions based on the position at which the impact-imparting event has occurred.

5. The non-transitory computer-readable storage medium according to claim 4, wherein a color and/or pattern of at least one mesh is set based on the second material data, wherein the at least one mesh is generated based on voxel data related to the change target voxels and a position of the at least one mesh has not changed before and after the impact-imparting event.

6. The non-transitory computer-readable storage medium according to claim 4, wherein:
when the impact-imparting event has occurred a first number of times on the object, it is determined by the processor that the change event has occurred for voxels of the object in a range in accordance with the impact-imparting event; and
the information processing further comprises: when the impact-imparting event has occurred a second number of times, which is larger than the first number of times, on the object, updating the voxel data related to removal target voxels of the object that are at positions based on the range in accordance with the impact-imparting event so that at least a portion of the object in the removal target voxels is removed; and
when the impact-imparting event has occurred the second number of times on the object, it is determined by the processor that the change event has occurred for at least some of the voxels around the removal target voxels.

7. The non-transitory computer-readable storage medium according to claim 1, wherein:
third material data is obtained by the processor;
in response to occurrence of the change event for a first time, a color and/or pattern of a mesh of the object generated based on voxel data related to the change target voxels that are at positions where the change event for the first time has occurred is set based on the second material data set for the change target voxels; and
in response to occurrence of the change event for a second time for the change target voxels, when the third material data is associated with the second material data set for the change target voxels at positions where the change event for the second time has occurred, a color and/or pattern of a mesh of the object generated based on voxel data related to the change target voxels is set based on the third material data.

8. The non-transitory computer-readable storage medium according to claim 1, wherein:
the material data is related to property data that defines a property of the object for each voxel, and the property data associated with the first material data and the property data associated with the second material data are the same; and
the information processing further comprises: setting a property of the object based on the property data.

9. The non-transitory computer-readable storage medium according to claim 1, wherein:
the material data includes data representing a texture; and
the information processing further comprises: generating an image of the object by applying, to a mesh that is generated based on the voxel data, a texture that is represented by the material data set for a voxel corresponding to the voxel data.

10. The non-transitory computer-readable storage medium according to claim 9, wherein an image of the object is generated by rendering a mesh that is generated based on voxel data of the change target voxels and voxel data of voxels that are different from the change target voxels so that there is a gradation from a texture represented by the first material data to a texture represented by the second material data.

11. One or more non-transitory computer-readable storage medium having stored therein instructions that, when executed, cause one or more processors of an information processing apparatus to execute information processing, the information processing comprising:
generating a mesh of an object in a virtual space based on voxel data for each voxel defined in a voxel space that is set in the virtual space;
before a removal event in which a portion of the object is removed occurs, rendering a first color and/or pattern on the mesh of the object; and
outputting an image of the mesh of the object in the virtual space on a display device, wherein:
after the removal event occurs, the voxel data is updated so that a portion of the object is removed; and
a second color and/or pattern different from the first color and/or pattern is rendered on a mesh of an exposed portion of the object that is exposed as a result of the removal and a mesh for at least a portion around the mesh of the exposed portion.

12. The non-transitory computer-readable storage medium according to claim 11, wherein the second color and/or pattern is rendered on a mesh that is for at least a portion around the mesh of the exposed portion and that is at least one mesh whose position has not changed before and after the removal event.

13. The non-transitory computer-readable storage medium according to claim 11, wherein the information processing further comprises:
obtaining property data that defines a property of the object for each voxel; and
setting a property based on the property data for the object in which the first color and/or pattern or the second color and/or pattern is rendered on the mesh,
wherein the property data corresponding to the mesh of the first color and/or pattern and the property data corresponding to the mesh of the second color and/or pattern are the same.

14. The non-transitory computer-readable storage medium according to claim 11, wherein a mesh that is generated based on the voxel data is rendered by using a texture that is associated with a voxel corresponding to the voxel data.

15. The non-transitory computer-readable storage medium according to claim 11, wherein a mesh for at least a portion around the mesh of the exposed portion is rendered so that there is a gradation from the first color and/or pattern to the second color and/or pattern.

16. An information processing system, comprising one or more processors that are configured to execute information processing comprising:
generating a mesh of an object in a virtual space based on voxel data for each voxel defined in a voxel space that is set in the virtual space;
obtaining first material data and second material data as material data that defines a color and/or pattern of the object defined for each voxel;
(a) before a change event that changes an appearance of the object occurs, setting a color and/or pattern of a mesh of the object based on the first material data, and (b) after the change event occurs, when the second material data is associated with the first material data that is set for change target voxels, which are voxels at a position at which the change event has occurred, setting, based on the second material data, a color and/or pattern of a mesh that is generated based on voxel data related to the change target voxels and that corresponds to a portion of a surface of the object; and
outputting an image of the mesh of the object in the virtual space on a display device.

17. An information processing apparatus comprising one or more processors that execute information processing comprising:
generating a mesh of an object in a virtual space based on voxel data for each voxel defined in a voxel space that is set in the virtual space;
obtaining first material data and second material data as material data that defines a color and/or pattern of the object defined for each voxel;
(a) before a change event that changes an appearance of the object occurs, setting a color and/or pattern of a mesh of the object based on the first material data, and (b) after the change event occurs, when the second material data is associated with the first material data that is set for change target voxels, which are voxels at a position at which the change event has occurred, setting, based on the second material data, a color and/or pattern of a mesh that is generated based on voxel data related to the change target voxels and that corresponds to a portion of a surface of the object; and
outputting an image of the mesh of the object in the virtual space on a display device.

18. An information processing method performed on an information processing system, the information processing method comprising:
generating a mesh of an object in a virtual space based on voxel data for each voxel defined in a voxel space that is set in the virtual space;
obtaining first material data and second material data as material data that defines a color and/or pattern of the object defined for each voxel;
(a) before a change event that changes an appearance of the object occurs, setting a color and/or pattern of a mesh of the object based on the first material data, and (b) after the change event occurs, when the second material data is associated with the first material data that is set for change target voxels, which are voxels at a position at which the change event has occurred, setting, based on the second material data, a color and/or pattern of a mesh that is generated based on voxel data related to the change target voxels and that corresponds to a portion of a surface of the object; and
outputting an image of the mesh of the object in the virtual space on a display device.
